(19) United States
(12) Patent Application Publication
(10) Pub. No.: US 2023/0046116 A1
(43) Pub. Date: Feb. 16, 2023

(54) HOT ISOSTATIC PRESSING HEAT TREATMENT OF BARS MADE FROM TITANIUM ALUMINIDE ALLOY FOR LOW-PRESSURE TURBINE BLADES FOR A TURBOMACHINE

(71) Applicant: Safran Aircraft Engines, Paris (FR)

(72) Inventors: Damien PONSEN, Moissy-Cramayel (FR); Guillaume Paul MARTIN, Moissy-Cramayel (FR); Volker GÜTHER, NÜRNBERG (DE)

(73) Assignee: Safran Aircraft Engines, Paris (FR)

(21) Appl. No.: 17/796,389

(22) PCT Filed: Jan. 29, 2021
(86) PCT No.: PCT/FR2021/050174

§ 371 Date: Jul. 29, 2022

(30) Foreign Application Priority Data
Jan. 31, 2020 (FR) FR2000949

(51) Int. Cl. C22F 1/18; C22F 1/00; F01D 5/28

(52) U.S. Cl. CPC C22F 1/183; C22F 1/002; F01D 5/286; F05D 2230/42; F05D 2300/174

(57) ABSTRACT

Disclosed is a method for the heat treatment of at least one bar made from titanium aluminide alloy for manufacturing at least one low-pressure turbine blade for a turbomachine, comprising hot isostatic pressing of the bar, characterised in that the hot isostatic pressing (121) is followed, after a temperature transition phase, by a step of heat treatment (122) of the bar at a temperature in the immediate vicinity of the eutectoid temperature of the alloy, the temperature being suitable for the formation of an alloy microstructure with a volume fraction of at least 90% single-phase grains γ and a volume fraction of at most 10% of lamellar grains α+γ, the step being followed by a controlled cooling step (123).

### FIELD OF THE INVENTION

The present invention relates to the manufacture of blades made from titanium aluminide alloy for a low-pressure turbine of a turbomachine for an aircraft.

In particular, it proposes a method for the heat treatment of bars made from titanium aluminide alloy for blades of a low-pressure turbine of a turbomachine.

### PRIOR ART AND GENERAL PROBLEM

### General Overview of Turbomachines

An axial flow turbofan engine is shown schematically in FIG. 1. The turbofan engine 1 comprises, in the air flow direction along the axis of the engine, a fan 2, a low-pressure compressor 3, a high-pressure compressor 4, a combustion chamber 5, a high-pressure turbine 6, a low-pressure turbine 7 and a propulsion nozzle (not shown).

The fan 1 and the low-pressure compressor 3 are linked to the low-pressure turbine 7 by a first transmission shaft 9, whereas the high-pressure compressor 4 and the high-pressure turbine 6 are linked by a second transmission shaft 10.

During operation, a flow of air compressed by the low- and high-pressure compressors 3 and 4 feeds combustion in the combustion chamber 5. The turbines 6, 7 recover kinetic energy from the expansion of the combustion gases before releasing it to the compressors 3, 4 and to the fan 2 via the transmission shafts 9,10.

### Titanium Aluminide Alloys

During operation, the blades of a low-pressure turbine are used at very high temperatures and are subjected to major mechanical and thermal stress.

In some engines, the blades of a low-pressure turbine are now made from titanium aluminide (TiAl).

Indeed, TiAl, an alloy of titanium and aluminum, is an extremely high-performance material. In particular, it has excellent mechanical properties at very high temperatures (T>650° C.); its density allows the weight of a blade to be reduced by at least half compared to the nickel alloys traditionally used in low-pressure turbines.

In particular, a titanium alloy commonly used for the blades of a low-pressure turbine of a turbomachine is TiAl 48-2-2, of formula Ti₄₈Al₄₈Cr₂Nb₂ (in at %). Other alloys of composition Ti₄₅₋₅₂—Al₄₅₋₄₈—X₁₋₃—Y₂₋₅—Z_{21 1}, in which X═Cr, Mn, V; Y═Nb, Ta, W, Mo; Z═Si, B, C or other accidental impurities, may also be considered.

### Mechanical Properties and Morphology of Microstructures According to Heat Treatment

The phase diagram of a TiAl alloy (Ti (left) and Al (right)) is shown in FIG. 2. The temperature range is 950-1600° C. and the atomic content of aluminum is 36-56 at %. The diagram shows five single-phase regions:

liquid region L;

primary α solid solution region of Al in Ti;

primary γ solid solution region of Ti in Al;

primary α₂ solid solution region of Al in Ti;

primary β solid solution region;

As can be seen in FIG. 2, the heat treatments to which the alloy is subjected during manufacture have a major impact on the microstructures obtained for the alloy.

Therefore:
with heat treatment carried out at a temperature higher than the α-to-γ phase transition temperature T_{α}, a completely lamellar microstructure is formed; this microstructure is made up of plates of α phase (zone (a));
with heat treatment carried out at a temperature slightly lower than the temperature T_{α}, a nearly lamellar structure is obtained, made up of alternating plates of α and γ phases that are stacked in lamellae, creating grains with a striped appearance (zone (b));
with heat treatment carried out at intermediate temperatures between the eutectoid temperature Tₑ and T_{α}, a duplex microstructure is obtained with a variable volume fraction of lamellar grains (two-phase lamellar grains—intermediate zone (c));
with heat treatment carried out at temperatures slightly higher than the eutectoid temperature Tₑ, a near-gamma microstructure is obtained, with a high content of equiaxed γ-phase grains (zone (d)).

For general presentations on TiAl alloys in the context of aeronautical applications, reference can advantageously be made to the following publications:
H. Clemens, H. Kestler, Advanced Engineering Materials (2000), 2, No. 9;
H. Clemens, H. Kestler, Herstellung, Verarbeitung und Anwendungen von g/TiAl-Basislegierungen Titan und Titanlegierungen, (2002) Wiley-VCH Verlag;
Chapter 9—Titanium alloys for aerospace structures and engines, Introduction to Aerospace Materials, Woodhead Publishing, 2012;
B. P. Bewlay, S. Nag, A. Suzuki Et M. J. Weimer, Materials at High Temperatures (2016), 33:4-5, 549-559;
F. Appel, R. Wagner, Materials Science and Engineering R22 (1998) 187-268;
J. Thepin, M. Nazmy, Materials Science and Engineering A 380 (2004) 298-307.

### Machining of Bars and Hot Isostatic Pressing

One technique for manufacturing the blades of a low-pressure turbine consists in machining them from bars made from titanium aluminide.

The term “bar” should be understood here in a fairly broad sense. It denotes a generally cylindrical unfinished product. Once obtained, the bars are machined. Various heat treatments may also be applied before, during or after machining, in order to create the blades.

It is known that, in order to facilitate the machining of the bars, it is desirable for them to be free of pores.

Heat treatments for TiAl alloy in which hot isostatic pressing (HIP) is applied to the bars are already known.

Hot isostatic pressing consolidates the materials at temperatures lower than their melting temperature and closes the pores.

In order to obtain the desired microstructure, the hot isostatic pressing phase is combined with other heat treatment phases, which help generate γ grains, typically:
homogenization heat treatment prior to the HIP phase, followed by cooling to room temperature,
heat treatment for stress relaxation and microstructure formation, following the HIP phase and cooling to room temperature, this heat treatment itself being a controlled cooling operation.

The alloys obtained at the end of these different phases are conventionally alloys with a duplex microstructure with, at best, 60/70% single-phase γ grains (60/70% of the volume), the remainder consisting of lamellar α+γ grains.

Such duplex alloys offer the advantage of having the desired mechanical properties at high temperatures, of being low-density and of having, when cold, the ductility/strength characteristics required in order to allow the blades to be fitted or removed.

However, the heat treatments with hot isostatic pressing that are currently known have the major drawback of being particularly costly.

In particular, the various heat treatment phases and the cooling operations between these phases impose particularly long cycle times (up to 11/12 hours).

Furthermore, the various operations that involve handling the bars, including moving them in and out of furnaces, result in aluminum losses which may not be insignificant.

Documents U.S. Pat. No. 5,609,608, US2013251537, EP2641984 and U.S. Pat. No. 5,350,466 propose various examples of heat treatment following isostatic pressing of Ti—Al alloys.

### DISCLOSURE OF THE INVENTION

A general aim of the invention is to overcome the disadvantages of the prior art.

In particular, one aim of the invention is to propose a solution that makes it possible to obtain a TiAl alloy that has mechanical properties compatible with what is required of blades of a low-pressure turbine of a turbomachine, at both high temperatures (operating temperatures of the low-pressure turbine) and when cold (fitting, removal of the blade).

Yet another aim of the invention is to propose a solution resulting in bars that offer good machinability, while being optimal in terms of cost.

In particular, according to one aspect, a method is proposed that makes it possible to produce pore-free bars made from a titanium aluminide alloy with a microstructure as close as possible to 100% γ (almost 100% γ).

An almost 100% γ microstructure (also known as a “near y” microstructure) should be understood here and in the present text as a whole to mean a microstructure with at least 90% single-phase γ grains (90% of the volume or more) and therefore with less than 10% lamellar α+γ grains (10% of the volume or less).

The parts obtained in this way have optimal qualities in terms of machinability and mechanical properties both at high temperatures and when cold.

The proposed method also has the advantage of greatly reducing the cycle time: it is implemented in a single heat treatment operation, without intermediate cooling to room temperature between the steps of this treatment.

Therefore, the invention proposes a method for the heat treatment of at least one bar made from titanium aluminide alloy for manufacturing at least one blade of a low-pressure turbine of a turbomachine, comprising hot isostatic pressing of the bar, characterized in that said hot isostatic pressing is followed, after a temperature transition phase, by a step of heat treatment of the bar at a temperature in the immediate vicinity of the eutectoid temperature of the alloy, said temperature being suitable for the formation of an alloy microstructure with a volume fraction of at least 90% single-phase γ grains and a volume fraction of at most 10% lamellar α+γ grains, said step being followed by a controlled cooling step.

It should be noted that none of documents U.S. Pat. No. 5,609,608, US2013251537, EP2641984 and U.S. Pat. No. 5,350,466 cited above focuses on “near gamma” configurations. None of them provides teaching relating to how such a configuration is obtained by means of heat treatment at a target temperature corresponding to the eutectoid temperature.

Moreover, none of these documents discloses controlled cooling.

Such a method is advantageously supplemented by the various following features, taken individually or, where technically possible, in combination:
all of the steps of said treatment are implemented in the same furnace;
the hot isostatic pressing is implemented at a temperature of between 1175° C. and 1195° C., at a pressure of at least 1300 bar, for a time period of between 3 hours and 5 hours;
the heat treatment that follows the hot isostatic pressing (12) is carried out at a target temperature of 1150° C.+/−20° C., preferably +/−10° C., for a time period of between 3 hours and 7 hours;
the temperature of the heat treatment that follows the hot isostatic pressing is adjusted depending on the amount of oxygen in the furnace in which said heat treatment is implemented;
the duration of the temperature transition phase is 60 minutes or less;
the controlled cooling is carried out at a cooling rate of between 2 and 56° C./minute, to a temperature of between 580° C. and 620° C.

The invention also proposes a bar made from titanium aluminide alloy for manufacturing at least one blade of a low-pressure turbine of a turbomachine, characterized in that it is obtained by means of a method as cited above and has an alloy microstructure with a volume fraction of at least 90% single-phase γ grains and a volume fraction of at most 10% lamellar α+γ grains.

It further proposes a method for manufacturing at least one blade of a low-pressure turbine of a turbomachine, and a turbine blade obtained by means of such a method and having an alloy microstructure with a volume fraction of at least 90% single-phase γ grains and a volume fraction of at most 10% lamellar α+γ grains.

### DESCRIPTION OF THE FIGURES

Other features, aims and advantages of the invention will become clearer from the description that follows, which is purely illustrative and non-limiting, and which should be read in reference to the appended drawings, in which:

FIG. 1, which has already been described, is a schematic representation of a turbomachine;

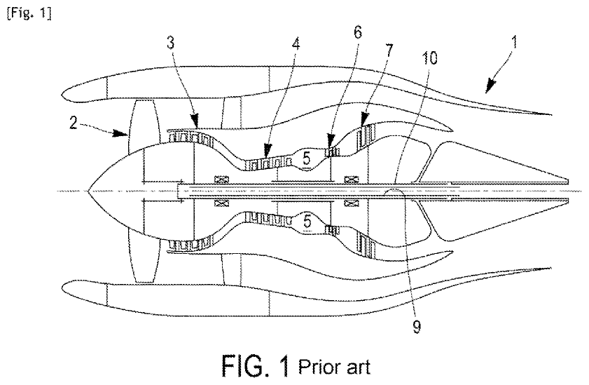

FIG. 2, which has already been described, is a phase diagram of a TiAl alloy;

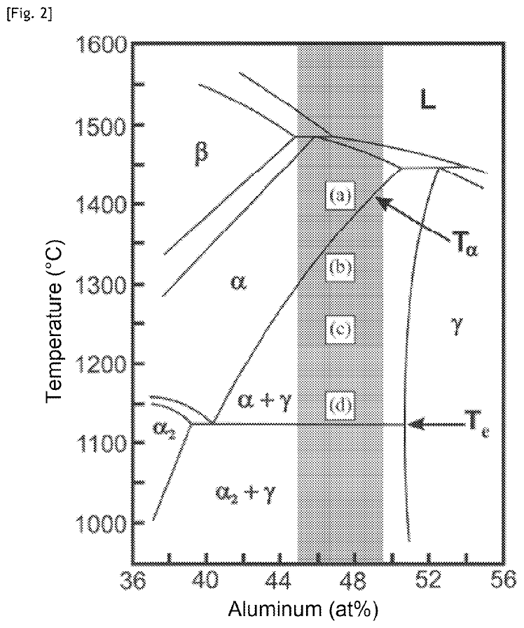

FIG. 3 is a flowchart showing the main steps of a method for manufacturing blades made from titanium aluminide alloy for a low-pressure turbine of a turbomachine, according to one possible embodiment of the invention;

FIG. 4 is a schematic representation, in perspective view, of a bar from which at least two blades are intended to be machined;

FIG. 5 is a temperature/time diagram showing the different phases of the heat treatment step of the manufacturing method of FIG. 3.

### DETAILED DESCRIPTION OF THE INVENTION

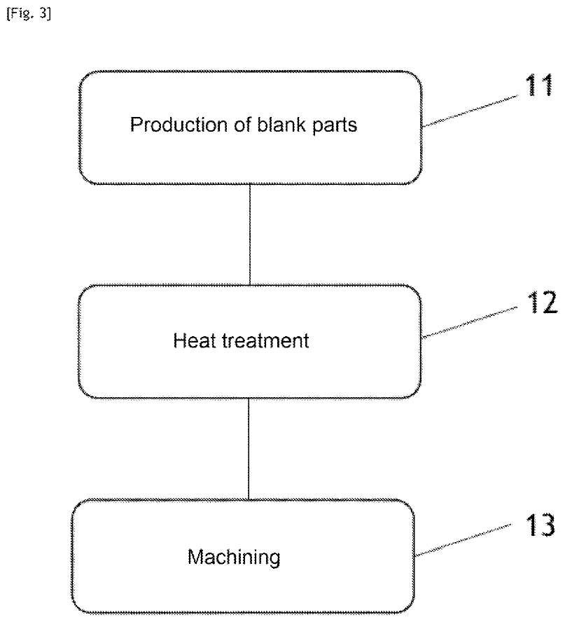

The method for manufacturing blades for a low-pressure turbine of a turbomachine shown in FIG. 3 implements, successively:
the production of the bars (step 11),
heat treatment of same (step 12),
a machining treatment (step 13).

Production of the Bars (Step 11)

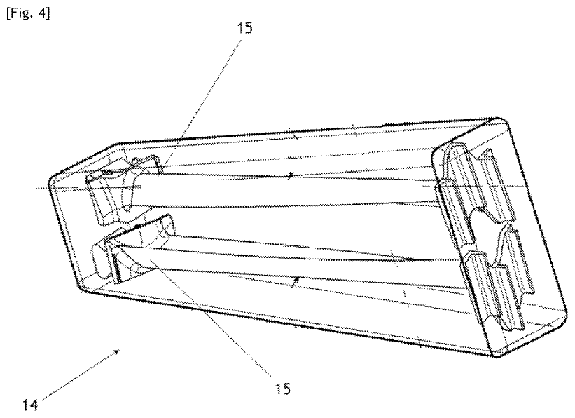

An example of a bar 14 (in this instance, one bar), from which at least two blades 15 are intended to be machined, is provided in FIG. 4.

Such a bar is cylindrical or polyhedral.

For example, it has a length of between 20 and 50 cm and transverse dimensions ranging from 1 to 10 cm.

Different techniques may be used to produce such bars 14 (step 11).

In particular, the bars 14 may be obtained by being cut from an ingot that is itself obtained either by molding (“lost-wax molding” or “centrifugal molding”, for example) or by fusion (“plasma arc fusion” or “vacuum arc fusion”).

Examples as to how these parts may be obtained are described, in particular, in application WO2014/057222 to which reference is made here.

The titanium aluminide alloy used to produce the ingots is typically an alloy of composition Ti₄₅₋₅₂—Al₄₅₋₄₈—X₁₋₃—Y₂₋₅—Z_{<1}, in which: X═Cr, Mn, V; Y═Nb, Ta, W, Mo; Z═Si, B, C or other accidental impurities.

A preferred alloy is TiAl 48-2-2, although other titanium aluminide alloys are possible.

Heat Treatment of the Bars (Step 12)

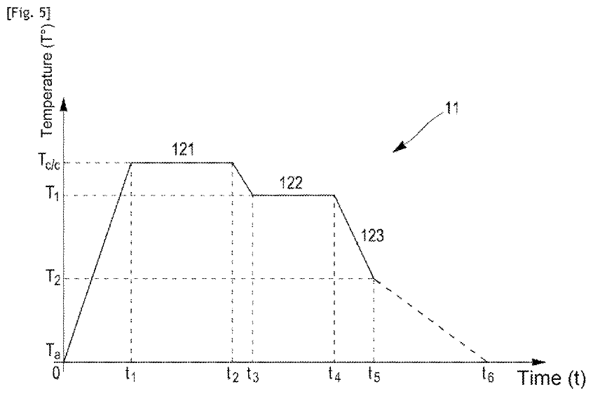

The bars 14 obtained in this way are then subjected to the heat treatment shown in FIG. 5.

This treatment combines a step 121 of hot isostatic pressing (HIP treatment) and, following this step of HIP and after a temperature transition phase, heat treatment 122 for the creation and nucleation of γ grains, this heat treatment itself being followed by controlled cooling 123.

To this end, the bars 14 are installed in a sealed furnace equipped with means for implementing hot isostatic pressing.

HIP treatment: In a first step (step 121 from time t₁ to time t₂), hot isostatic pressing is implemented.

This treatment is, for example, implemented at a temperature of between 1175° C. and 1195° C. (temperature of the furnace) and at a pressure of at least 1300 bar, for a time period of between 3 hours and 5 hours.

During this HIP step, the internal pores of the bars 14 are closed.

Heat treatment for the creation and nucleation of the γ grains: step 121 is followed by a step of heat treatment at a temperature T1 that allows the creation and nucleation of the γ grains (step 122 from time t3 to time t4).

Temperature T1 is in the vicinity of the eutectoid temperature. More specifically, the target temperature is 1150° C. (+/−20° C., i.e., a temperature of between 1130° C. and 1170° C., preferably +/−10° C., i.e., a temperature of between 1140° C. and 1160° C.). In the present text as a whole, the indicated temperatures refer to the temperatures at the core of the material (obtained by means of sensors and thermocouples).

The duration of this step is at most equal to 7 hours, and preferably at least 3 hours.

It is adjusted depending on the amount of oxygen in the furnace in order to allow the creation and nucleation of the γ grains, in order to form the almost 100% γ microstructure.

Indeed, the eutectoid temperature varies depending on the amount of oxygen. At an oxygen level of 400 ppm, the temperature T₁ is 1150° C., and it drops to 1100° C. when the oxygen increases to 1000 ppm. The relationship between the amount of oxygen and the eutectoid temperature is almost linear.

In the context of the proposed heat treatment, the treatment temperature of the material is always 1150° C. (+/−20° C., preferably +/−10° C.). The oxygen level is adjusted empirically.

During this step 122, the pressure in the furnace may be kept at at least 1300 bar, which then allows the duration of the HIP step 121 to be reduced.

As a variant, the alloy may be placed under vacuum in order to prevent possible parasitic chemical reactions between the alloy and residual atmospheric gases.

It should be noted that the transition between steps 121 and 122 (from time t₂ to time t₃) is obtained by cooling, for example under an inert gas such as argon.

The duration of this cooling is less than 60 minutes and is preferably less than 40 minutes, or indeed than 20 minutes. This cooling duration (t₃-t₂) may be optimized according to industrial constraints and does not produce any particular microstructural advantages.

Controlled cooling: Following step 122, the bars 14 are subjected to controlled cooling (step 123 between t₄ and t₅).

The cooling speed is between 2 and 56° C. per minute.

The temperature at the end of this cooling is between 580° C. and 620° C.

This controlled cooling causes the residual lamellar grains to set and makes it possible to obtain the desired mechanical properties.

It should be noted that excessively swift cooling would have an impact on the mechanical properties. In particular, it would be likely to produce precipitates within the single-phase γ grain and adversely affect the mechanical properties thereof when hot (during operation).

Such cooling may, for example, be carried out with a furnace equipped with URC (Uniform Rapid Cooling) technology.

The bars 14 are then cooled in a non-controlled manner (starting from t₅) until they reach room temperature (t₆). This step has no particular effect on the microstructure.

As can be seen, the proposed heat treatment allows a cycle time far shorter than with the heat treatments known from the prior art.

Therefore, the parts are no longer removed from the furnace and brought to room temperature between each step, greatly shortening the heat treatment time.

Moreover, the proposed heat treatment makes it possible to obtain a “near γ” (90%) microstructure supplemented by lamellar structures or a 100% γ microstructure with the method according to the invention. A microstructure obtained in this way has optimal qualities in terms of machinability, production cost and mechanical properties at high temperature for the manufacture of blades of a low-pressure turbine.

Machining Treatment (Step 13)

Following the heat treatment, the bars 14 are subjected to machining with tools conventionally used for this purpose.

This machining makes it possible to obtain the blades 15 shown, by transparency, in the bar 14 in FIG. 4. The cutting is optimized in order to allow maximum use of the material.

Like the bar 14 from which it originates, the blade has an alloy microstructure with a volume fraction of at least 90% single-phase γ grains and a volume fraction of at most 10% lamellar α+γ grains.

Once cut, the blades 15 may be further treated (thermally or otherwise) before being considered to be fully finished.

Also, other heat treatments may be carried out on the bars 14 before machining.

1. A method for heat treating a bar made from titanium aluminide alloy for manufacturing at least one blade of a low-pressure turbine of a turbomachine, comprising:
hot isostatic pressing of the bar,
subsequent to hot isostatic pressing and after a temperature transition phase, heat treating the bar at a temperature in an immediate vicinity of a target temperature that is the eutectoid temperature of the titanium aluminide alloy and forming an alloy microstructure with a volume fraction of at least 90% single-phase γ grains and a volume fraction of at most 10% lamellar α+γ grains, and
further comprising after heat treating the bar, cooling the bar in a controlled manner to a given temperature.

2. The method according to claim 1, wherein heat treating the bar is carried out at the target temperature of 1150° C.+/−20° C. for a time period of between 3 hours and 7 hours.

3. The heat treatment method according to claim 1, wherein the hot isostatic pressing is implemented at a temperature of between 1175° C. and 1195° C., at a pressure of at least 1300 bar, for a time period of between 3 hours and 5 hours.

4. The method according to claim 1, wherein the steps of hot isostatic pressing, heat treating the bar, and cooling the bar are implemented in the same furnace.

5. The method according to claim 1, further comprising adjusting the temperature in the immediate vicinity of the target temperature depending on an amount of oxygen in a furnace in which heat treating the bar is implemented.

6. The method according to claim 1, wherein a duration of the temperature transition phase is 60 minutes or less.

7. The method according to claim 1, wherein cooling the bar is carried out at a cooling rate of between 2 and 56° C./minute, to a temperature of between 580° C. and 620° C.

8. A bar made from titanium aluminide alloy for manufacturing at least one blade of a low-pressure turbine of a turbomachine, wherein the bar is obtained by the method according to claim 1 and has the alloy microstructure with the volume fraction of at least 90% single-phase γ grains and the volume fraction of at most 10% lamellar α+γ grains.

9. A method for manufacturing at least one blade of a low-pressure turbine of a turbomachine, comprising following steps:
heat treating the bar according to the method of claim 1, and
machining the bar to form a blade.

10. A blade of a low-pressure turbine of a turbomachine, wherein the blade is obtained by the method according to claim 9 and has the alloy microstructure with the volume fraction of at least 90% single-phase γ grains and a volume fraction of at most 10% lamellar α+γ grains.
